(19) United States
(12) Patent Application Publication
(10) Pub. No.: US 2020/0001818 A1
(43) Pub. Date: Jan. 2, 2020

(54) CONSTANT PRESSURE SIDE CURTAIN AIRBAG

(71) Applicant: TRW Vehicle Safety Systems Inc., Washington, MI (US)

(72) Inventors: DYLAN P. MORAN, Rochester Hills, MI (US); MASOOD A. MOHAMMAD, Rochester, MI (US); SONGWEI ZHANG, Washington, MI (US); MICHELLE BLACKSON, Washington, MI (US)

(21) Appl. No.: 16/023,151

(22) Filed: Jun. 29, 2018

(51) Int. Cl. B60R 21/239; B60R 21/214; B60R 21/231; B60R 21/232; B60R 21/2338

(52) U.S. Cl. CPC B60R 21/239; B60R 21/214; B60R 21/23138; B60R 2021/23509; B60R 21/2338; B60R 2021/23382; B60R 21/232

(57) ABSTRACT

A curtain airbag configured to maintain an internal working pressure of the airbag when an internal working pressure exceeds a design working pressure. The curtain airbag can include pressure relief elements that are actuatable to increase the inflatable volume of the curtain airbag. The curtain airbag can include a relief vent that opens when the internal working pressure exceeds the design working pressure and subsequently close when the internal working pressure falls below the design working pressure.

### FIELD OF THE INVENTION

The present invention relates to a vehicle occupant protection device and, in particular, to arrangements for maintaining an internal working pressure of a curtain airbag at a design working pressure.

### BACKGROUND TO THE INVENTION

It is known to inflate a vehicle occupant protection device to help protect a vehicle occupant upon the occurrence of an event for which occupant protection is desired (e.g., vehicle collision or vehicle rollover). One example of such a vehicle occupant protection device is a curtain airbag. Curtain airbags can be inflated from a stored condition away from a vehicle roof to a deployed position in which the airbag is positioned between a side structure of the vehicle and the vehicle occupant.

Curtain airbags are typically sealed systems and, as a result, will exhibit different internal working pressures at different altitudes and environmental conditions (e.g., temperature). For example, it has been found that a decrease of 2 psi in ambient pressure can result in an internal working pressure increase of approximately 2 psi.

Due to fabric properties (e.g., stretch) and curtain airbag performance targets, it can be desirable to maintain the internal working pressure of the curtain airbag regardless of altitude and environmental conditions. For example, since curtain airbags have a comparatively small inflated depth into which the occupant can penetrate in the event of a crash, it can be desirable to maintain the internal working pressure of the curtain airbag at the design working pressure so as to avoid the occupant penetrating too far into the airbag. If, however, the airbag is over pressurized, the airbag can become too “hard” and, as a result, fail to afford the desired level of occupant protection.

### SUMMARY OF THE INVENTION

According to one aspect of the invention, a curtain airbag includes a first panel and a second panel connected to the first panel to define an inflatable volume of the curtain airbag. A plurality one or more pressure relief elements are actuatable to increase the inflatable volume of the curtain airbag when an internal working pressure of the curtain airbag exceeds a design working pressure. The pressure relief elements are configured such that the increase in the overall volume of the curtain airbag reduces the internal working pressure to the design working pressure.

According to another aspect of the invention, a curtain airbag includes a first panel and a second panel connected to the first panel to define an inflatable volume of the curtain airbag. A relief vent is configured to open when an internal working pressure of the curtain airbag exceeds a design working pressure. The relief vent is further configured to close after opening when the internal working pressure of the airbag falls below the design working pressure.

### BRIEF DESCRIPTION OF THE DRAWINGS

Embodiments of the invention will now be described by way of example only, with reference to the accompanying drawings, in which:

FIG. 1 is a side view of a deployed curtain airbag;

FIG. 2 is a head-on view of the deployed curtain airbag of FIG. 1;

FIG. 3 is a plan view of a curtain airbag according to one embodiment of the present invention;

FIG. 4A is a view of part of the curtain airbag of FIG. 3 in a first condition;

FIG. 4B is a view of part of the curtain airbag of FIG. 3 in a second condition;

FIG. 5 is a plan view of a curtain airbag according to another embodiment of the present invention;

FIG. 6A is a view of part of the curtain airbag of FIG. 5 in a first condition;

FIG. 6B is a view of part of the curtain airbag of FIG. 5 in a second condition;

FIG. 7A is a plan view of a curtain airbag according to another embodiment of the present invention

FIG. 7B is another plan view of the curtain airbag of FIG. 7A; and

FIG. 8 is a graph showing inflation characteristics of the curtain airbag of FIG. 7.

### DETAILED DESCRIPTION

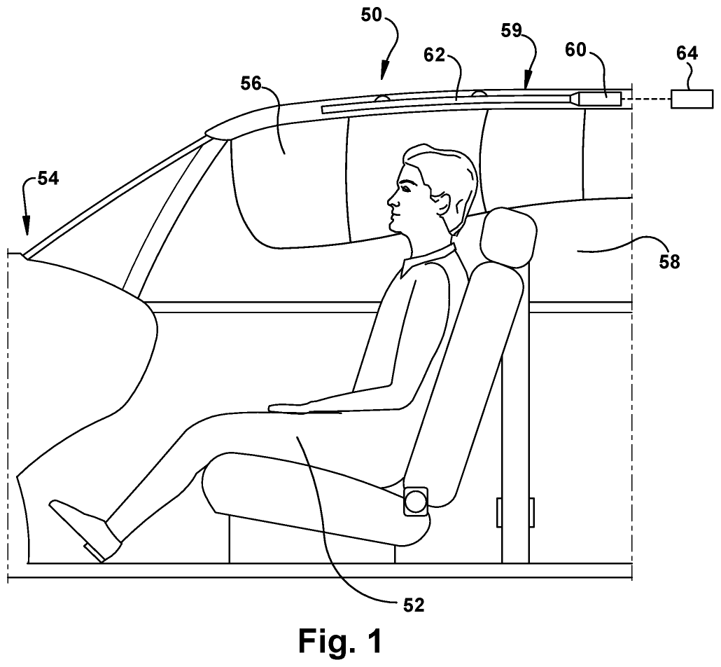

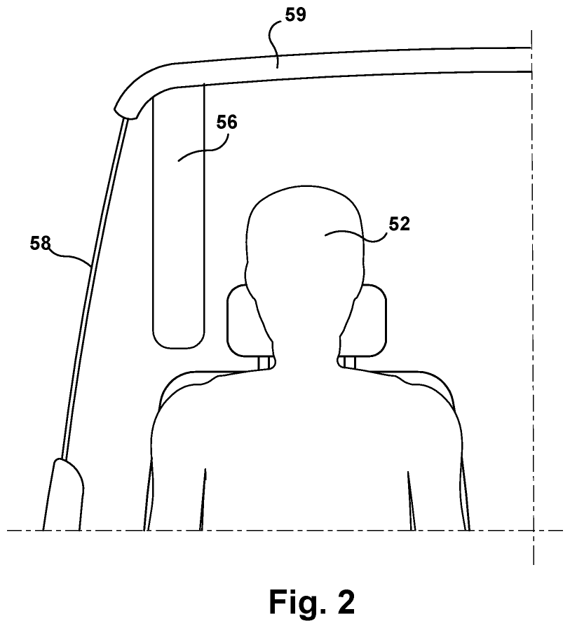

An example configuration of an apparatus 50 for helping to protect an occupant 52 of a vehicle 54 is shown in FIGS. 1 and 2. The apparatus 50 includes an inflatable vehicle occupant protection device in the form of a curtain airbag 56. In a stored condition (not shown), the curtain airbag 56 can be rolled, folded, or rolled and folded, and positioned adjacent an intersection of a side structure 58 and a roof 59 of the vehicle 54. The stored curtain airbag 56 can be concealed by a concealing structure (e.g., headliner, trim pieces, padding, and/or upholstery). The curtain airbag 56 is inflatable from the stored condition to a deployed condition that is shown in FIGS. 1 and 2. In the deployed condition, the curtain airbag 45 extends along the side structure 58 of the vehicle 54 and is positioned between the side structure 58 and the vehicle occupant 52.

The apparatus 50 also includes an inflation fluid source in the form of an inflator 60. The inflator 60 is actuatable to provide inflation fluid for inflating the curtain airbag 56. In one example, the inflator 60 is in fluid communication with the curtain airbag 56 through a fill tube 62. However, it is contemplated that that the fill tube 62 may be omitted and the inflation fluid can be discharged into the curtain airbag 56 directly or through a manifold.

Upon sensing the occurrence of an event for which inflation of the curtain airbag 56 is desired, a sensor 64 provides a signal to the inflator 60. The inflator 60 is actuated upon receipt of the signal, thereby causing the inflator 60 to provide inflation fluid to the curtain airbag 56. The inflating curtain airbag 56 exerts a force on the concealing structure that causes the concealing structure to open (i.e., tear and/or displaced) as the curtain airbag 56 transitions to the deployed condition.

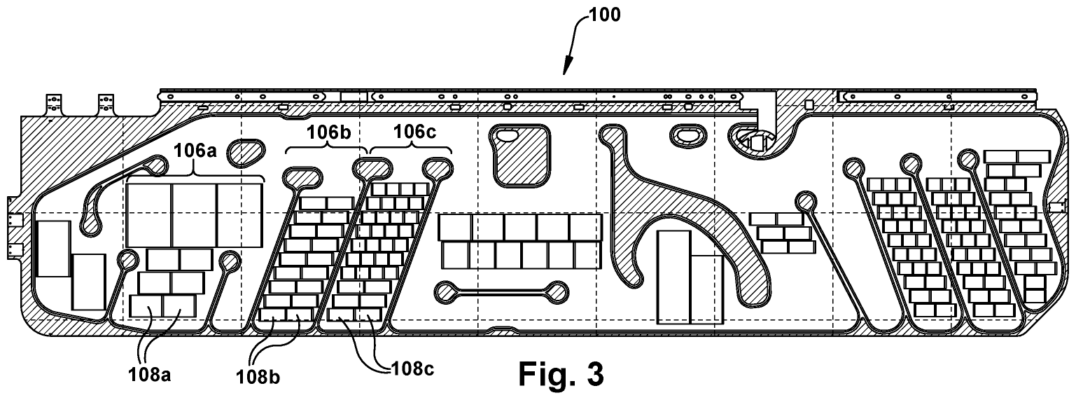

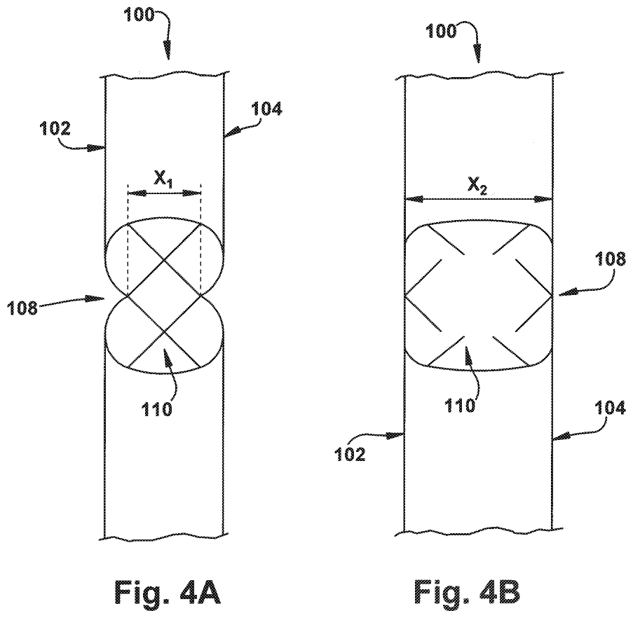

FIGS. 3 and 4 show an example configuration of a curtain airbag 100 that can be used in the apparatus 50 of FIGS. 1 and 2. In one example, the curtain airbag 100 is manufactured as a one-piece woven airbag. It is contemplated, however, that the curtain airbag 100 can be manufactured using any desired technique. The curtain airbag 100 includes an inboard panel 102 and an outboard panel 104 that are connected to one another to define an inflatable volume of the curtain airbag. In the deployed condition of the curtain airbag 100 the inboard panel 102 is presented facing the occupant 52 and the outboard panel 104 is presented facing the vehicle side structure 5.

The distance between the inboard panel 102 and the outboard panel 104 (i.e., the depth) of the inflated curtain airbag 100 can be relatively small due to the fact that the airbag is of a curtain type. As such, it is desired to maintain the curtain airbag 100 at a specified design working pressure to ensure that the airbag is not too “hard” while also not being too “soft”. To this end, the curtain airbag 100 can be configured to prevent over pressurization while also avoiding under-pressurization by incorporating one or more pressure relief elements that help maintain the curtain airbag 100 at a design working pressure. The pressure relief elements can be structures that are actuatable in response to an internal working pressure of the curtain airbag 100 exceeding the design working pressure.

In the example configuration of FIGS. 3 and 4, the pressure relief elements are tethers 110 that interconnect the inboard panel 102 and the outboard panel 104. In one example, the tethers 110 are woven into the curtain airbag 100 as part of the one-piece woven manufacturing process. However, that the tethers 110 can be provided using any desired process. In the example configuration of FIGS. 3 and 4, the tethers 110 are configured to have an X-shape. The tethers 110, however, can have alternative configurations without departing from the spirit and scope of the invention.

The tethers 110 are arranged to maintain the inflated depth of the curtain airbag 100 to a desired dimension when the curtain airbag is at or below the design working pressure. In response to the curtain airbag 100 exceeding the design working pressure, the tethers 110 are configured to release the connection between the inboard panel 102 and the outboard panel 104, which allows the panels to move away from each other, thereby increasing the volume of the curtain airbag and lowering the internal working pressure as a result.

The tethers 110 can be arranged in clusters 106 that cover and control the inflated depth of certain regions of the curtain airbag 100. These regions can, for example, be regions configured to be positioned adjacent the occupant 52 when the airbag 100 is deployed and/or regions not positioned adjacent the occupant 52 when the airbag 100 is deployed. As an example of regions not positioned adjacent to the occupant 52, the clusters 106 can be arranged on a portion of the curtain airbag 100 that is adjacent to the A-pillar, the B-pillar, the C-pillar, and/or the D-pillar of the vehicle. The curtain airbag 100 is configured to provide the desired level of occupant protection regardless of the positioning of the clusters 106 and regardless of whether the tethers 110 are intact or have released.

In a first inflated condition (FIG. 4A), the internal working pressure of the curtain airbag 100 is at or below the design working pressure. In this condition, the tether 110 limits a portion of the curtain airbag 100 associated with the tether to a first depth X₁. In a second inflated condition (FIG. 4B), the internal working pressure of the curtain airbag 100 exceeds the design working pressure. In this condition, the tether 110 releases, which allows the portion of the curtain airbag 100 associated with the tether to expand to a second depth X₂ that is greater than the first depth X₁. The increase in depth increases the overall inflatable volume of the curtain airbag 100, which, according to the Ideal gas law, causes the internal working pressure of the curtain airbag 100 to decrease.

The tethers 110 of specific clusters 106 can be configured to release at specific internal working pressures of the curtain airbag 100. In one example, the curtain airbag 100 has a design working pressure of 10 psi and includes three separate relief clusters 106a, b, c. The tethers 110a of the first relief cluster 106a are configured to release when the internal working pressure of the curtain airbag 100 exceeds 12 psi, the tethers 110b of the second relief cluster 106b are configured to release when the internal working pressure of the curtain airbag 100 exceeds 14 psi, and the tethers 110c of the third relief cluster 106c are configured to release when the internal working pressure of the curtain airbag 100 exceeds 16 psi. According to this example, if the internal working pressure of the curtain airbag 100 reaches 13 psi, the tethers 110a of the first relief cluster 106a release and the tethers 110b, c of the second and third relief clusters 106b, c remain intact. If the internal working pressure of the curtain airbag 100 reaches 15 psi, the tethers 110a, 110b of the first and second relief clusters 106a, 106b release and the tethers 110c of the third relief cluster 106c remain intact. If the internal working pressure of the curtain airbag 100 reaches 17 psi, the tethers 110a, b, c of all three relief clusters 106a, b, c release.

The relief cluster 106 characteristics can be selected to maintain the internal working pressure of the curtain airbag 100 at the design working pressure. Continuing with the immediately preceding example, if the internal working pressure of the curtain airbag 100 reaches 13 psi, the characteristics of the first relief cluster 106a are selected such that the internal working pressure of the curtain airbag 100 drops to approximately 10 psi upon the release of the associated tethers 110a. If the internal working pressure of the curtain airbag 100 reaches 15 psi, the characteristics of the first and second relief clusters 106a, 106b are selected such that the internal working pressure of the curtain airbag 100 drops to approximately 10 psi upon the release of the associated tethers 110a, b. If the internal working pressure of the curtain airbag 100 reaches 17 psi, the characters of the first, second, and third relief clusters 106a, b, c are selected such that the internal working pressure of the curtain airbag 100 drops to approximately 10 psi upon the release of the associated tethers 110a, b, c. In other words, the internal working pressure of the curtain airbag 100 is maintained at the design working pressure as a result of the characteristics of the relief clusters 106 being selected such that the working volume of the curtain airbag 100 is increased. In other words, the internal working pressure of the curtain airbag 100 is reduced to the design working pressure as a result of the characteristics of the relief clusters 106 being selected so as to increase the inflatable volume of the curtain airbag 100 upon the release of the associated tethers 110 by an amount that provides a desired reduction of the internal working pressure.

The example configuration of the curtain airbag 100 shown and described herein is provided only as an example. It is contemplated that the described tethers 110 and clusters 106 can be provided to any desired curtain airbag construction having any desired dimensions and/or shapes. Additionally, the specifically disclosed number, shape, size, location etc. of tethers 110 and clusters 106 is provided only as an example. It is contemplated that the number, shape, size, location etc. of the tethers 110 and clusters 106 can be altered as desired. Furthermore, the specifically disclosed design working pressure of the curtain airbag 100 and the internal working pressures at which the tethers 110 release are provided only as an example. It is contemplated that the design working pressure of the curtain airbag 100 and the internal working pressures at which the tethers 110 release can be any desired pressure.

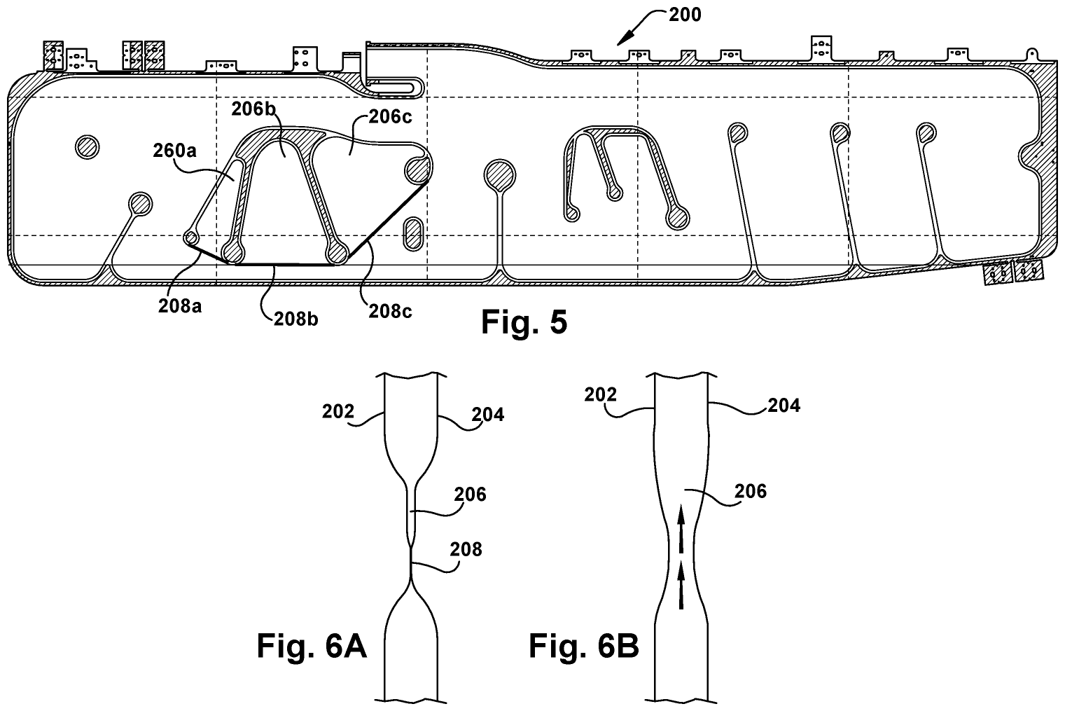

FIGS. 5 and 6 show another example configuration of a curtain airbag 200 that can be implemented in the apparatus 50 of FIGS. 1 and 2. Like the previous example configuration, the curtain airbag 200 is manufactured as a one-piece woven airbag and includes an inboard panel 202 and an outboard panel 204 that are connected to one another to define an inflatable volume of the curtain airbag. It is contemplated, however, that the curtain airbag 200 can be manufactured using any desired technique.

In the example configuration of FIGS. 5 and 6, the pressure relief elements are chambers 206. Each of the chambers 206 includes a sealing portion 208 that seals and end of the associated chamber 206. In one example, the sealing portion 208 can be provided as one or more yarns that are woven as a seam during the one-piece woven manufacturing process. The yarn(s) that form the seam can have a strength that is comparatively weaker than the strength of the yarns that are used to manufacture the rest of the curtain airbag 200. The sealing portion 208 can, however, be formed using any alternative construction methods that interconnects the panels 202, 204. Such construction methods can include, for example, stitching, adhesive bonding, and/or welding.

When the curtain airbag 200 is at or below the design working pressure, the sealing portion 208 attaches a portion of the inboard panel 202 to the outboard panel 204 so as to divorce the volume of the associated relief chamber 206 from the remainder of the inflatable volume of the curtain airbag 200. In response to the curtain airbag 200 exceeding the design working pressure, the sealing portion 208 is configured to release the connection between the inboard and outboard panels 202, 204, thereby allowing the volume of the associated relief chamber to contribute to and increase the overall inflatable volume of the curtain airbag

The relief chambers 206 can be arranged at various regions of the curtain airbag 200. These regions can, for example, be regions configured to be positioned adjacent the occupant 52 when the airbag 100 is deployed and/or regions not positioned adjacent the occupant 52 when the airbag 100 is deployed. As an example of regions not positioned adjacent to the occupant 52, the clusters 106 can be arranged on a portion of the curtain airbag 100 that is adjacent to the A-pillar, the B-pillar, the C-pillar, and/or the D-pillar of the vehicle. The curtain airbag 200 is configured to provide the desired level of occupant protection regardless of the positioning of the relief chambers 206 and regardless of whether the sealing portion 208 is intact or has released.

In a first inflated condition (FIG. 6A), the internal working pressure of the curtain airbag 200 is at or below the design working pressure. In this condition, the sealing portion 208 is intact and inflation fluid is not permitted to enter the relief chamber 206. In a second inflated condition (FIG. 6B), the internal working pressure of the curtain airbag 200 exceeds the design working pressure. In the second condition, the sealing portion 208 releases and inflation fluid is permitted to enter the relief chamber 206 (schematically indicated by arrow). The overall inflatable volume of the curtain airbag 200 is increased by the volume of the relief chamber upon 206 the release of the associated sealing portion 208 which, according to the Ideal gas law, causes the internal working pressure of the curtain airbag 200 to decrease.

The sealing portions 208 of specific relief chambers 206 can be configured to release at specific internal working pressures of the curtain airbag 200. In one example, the curtain airbag 200 has a design working pressure of 10 psi and includes three separate relief chambers 206a, b, c. The sealing portion 208a of the first relief chamber 206a is configured to release when the internal working pressure of the curtain airbag 200 exceeds 12 psi, the sealing portion 208b of the second relief chamber 206b is configured to release when the internal working pressure of the curtain airbag 200 exceeds 14 psi, and the sealing portion 208c of the third relief chamber 206c is configured to release when the internal working pressure of the curtain airbag 200 exceeds 62 psi. According to this example, if the internal working pressure of the curtain airbag 200 reaches 13 psi, the sealing portion 208a of the first relief chamber 206a release and the sealing portions 208b, c of the second and third relief chambers 206b, c remain intact. If the internal working pressure of the curtain airbag 200 reaches 15 psi, the sealing portions 208a, b of the first and second relief chambers 206a, 206b release the sealing portion 208c of the third relief chamber 206c remains intact. If the internal working pressure of the curtain airbag 200 reaches 17 psi, the sealing portions 208a, b, c of all three relief chambers 206a, b, c release.

The relief chamber 206 characteristics can be selected to maintain the internal working pressure of the curtain airbag 200 at the design working pressure. Continuing with the immediately preceding example, if the internal working pressure of the curtain airbag 200 reaches 13 psi, the characteristics of the first relief chamber 206a are selected such that the internal working pressure of the curtain airbag 200 drops to approximately 10 psi upon the release of the associated sealing portion 208a. If the internal working pressure of the curtain airbag 200 reaches 15 psi, the characteristics of the first and second relief chambers 206a, b are selected such that the internal working pressure of the curtain airbag 200 drops to approximately 10 psi upon release of the associated sealing portions 208a, b. If the internal working pressure of the curtain airbag 200 reaches 17 psi, the characteristics of the first, second, and third relief chambers 206a, b, c are selected such that the internal working pressure of the curtain airbag 200 drops to approximately 10 psi upon release of the associated sealing portions 208a, b, c. In other words, the internal working pressure of the curtain airbag 100 is maintained at the design working pressure as a result of the characteristics of the relief chambers 206 being selected so as to increase the inflatable volume of the curtain airbag 200 upon the release of the associated sealing portions 208 by an amount that provides a desired reduction of the internal working pressure.

The example configuration of the curtain airbag 200 shown and described herein is provided only as an example. It is contemplated that the described relief chambers 206 and sealing portions 208 can be provided to any desired curtain airbag construction having any desired dimensions and/or shapes. Additionally, the specifically disclosed number, shape, size, location etc. of the relief chambers 206 and sealing portions 208 is provided only as an example. It is contemplated that the number, shape, size, location etc. of the relief chambers 206 and sealing portions 208 can be altered as desired. Furthermore, the specifically disclosed design working pressure of the curtain airbag 200 and the internal working pressures at which the sealing portions 208 release are provided only as an example. It is contemplated that the design working pressure of the curtain airbag 200 and the internal working pressures at which the sealing portions 208 rupture may be at any desired pressure.

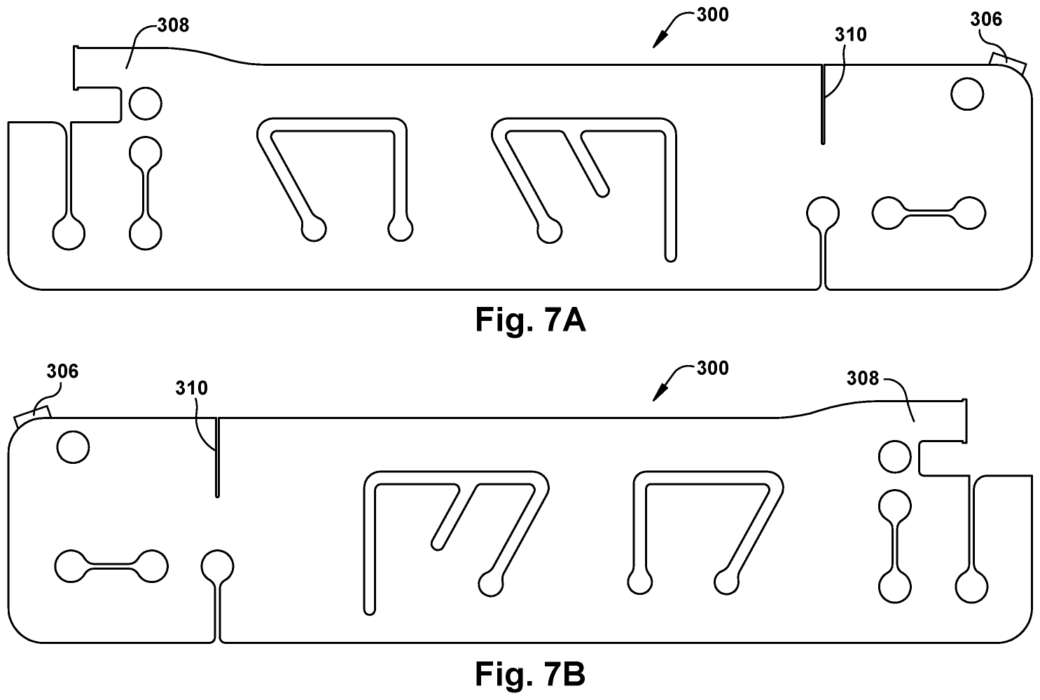

FIGS. 7a and 7b show another example configuration of a curtain airbag 300 that can be implemented in the apparatus of FIGS. 1 and 2. Like the previous example configurations, the curtain airbag 300 is manufactured as a one-piece woven airbag and includes an inboard panel 302 and an outboard panel 304 that are connected to one another to define an inflatable volume of the curtain airbag. It is contemplated, however, that the curtain airbag 300 can be manufactured using any desired technique.

In the example configuration of FIG. 7, the pressure relief element is a relief vent 306 provided at an end of the curtain airbag 300 opposite an inflation fluid inlet 308. It is contemplated, however, that more than one relief vent 306 can be provided to the curtain airbag 300. Furthermore, it is contemplated that the relief vent 306 (or relief vents) can be provided at any desired location on the curtain airbag 300 that is outside the direct area of the inflator where localized areas of high inflation fluid pressure can occur. This helps to prevent premature opening of the relief vent 306. To further help the prevention of premature opening of the relief vent 306, an internal tether 310 can be provided to the curtain airbag 300. The internal tether 310 can be arranged to disrupt inflation fluid flow from the inflation fluid inlet 308 directly to the relief vent 306 so as to prevent high pressure spikes at the relief vent location.

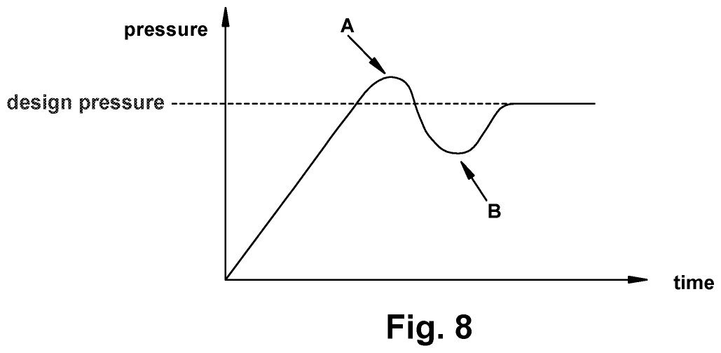

The relief vent 306 can be a resealing type relief vent. By resealing, it is meant that the relief vent 306 opens when the internal working pressure of the curtain airbag 300 rises above a prescribed pressure and then closes to seal the curtain airbag 300 when the internal working pressure of the curtain airbag 300 falls below that prescribed pressure. In one example, the design working pressure of the curtain airbag 300 is 10 psi. As shown in FIG. 8, the relief vent 306 can be configured to open (A) when the internal working pressure of the curtain airbag 300 exceeds 10 psi and then subsequently close (B) when the internal working pressure of the curtain airbag drops below 10 psi. Thus, the internal working pressure of the curtain airbag 300 is maintained at about 10 psi. It is contemplated that the relief vent 306 can be configured to open and close at any desired pressure.

The example configuration of the curtain airbag 300 shown and described herein is provided only as an example. It is contemplated that the described relief vent 306 and internal tether 310 can be provided to any desired construction having any desired dimensions and/or shapes.

What have been described above are examples of the disclosure. It is, of course, not possible to describe every conceivable combination of components or method for purposes of describing the disclosure, but one of ordinary skill in the art will recognize that many further combinations and permutations of the disclosure are possible. Accordingly, the disclosure is intended to embrace all such alterations, modifications, and variations that fall within the scope of this application, including the appended claims.

1. A curtain airbag for helping to protect an occupant of a vehicle comprising:
a first panel;
a second panel connected to the first panel to define an inflatable volume of the curtain airbag; and
one or more pressure relief elements that are actuatable to increase the inflatable volume of the curtain airbag in response to an internal working pressure of the curtain airbag exceeding a design working pressure, the one or more pressure relief elements being configured such that the increase in the inflatable volume of the curtain airbag reduces the internal working pressure to the design working pressure.

2. The curtain airbag of claim 1, wherein the one or more pressure relief elements are tethers that interconnect the first panel and the second panel.

3. The curtain airbag of claim 2, wherein the tethers are actuated in response to the internal working pressure exceeding the design working pressure to allow the curtain airbag to expand from a first depth to a second depth.

4. The curtain airbag of claim 2, wherein the tethers are arranged to form an “X” shape.

5. The curtain airbag of claim 2, wherein the curtain airbag is a one-piece woven airbag.

6. The curtain airbag of claim 5, wherein the tethers are woven into the curtain airbag as part of the one-piece woven manufacturing process.

7. The curtain airbag of claim 2, wherein the tethers are arranged in a plurality of clusters, the tethers of a first cluster of the plurality of clusters being configured to release when the internal working pressure of the curtain airbag is at a first level, the tethers of a second cluster of the plurality of clusters being configured to release when the internal working pressure of the curtain airbag is at a second level.

8. The curtain airbag of claim 7, wherein both the tethers of the first cluster and the tethers of the second cluster release when the internal working pressure is at the second level.

9. The curtain airbag of claim 1, wherein one or more pressure relief elements are relief chambers having a sealing portion that attaches a portion of the inboard panel to the outboard panel to seal the respective relief chamber and divorce a volume of the respective relief chamber from a remainder of the inflatable volume of the curtain airbag.

10. The curtain airbag of claim 9, wherein the curtain airbag is a one-piece woven airbag.

11. The curtain airbag of claim 10, wherein the sealing portions are provided as a yarn that is woven into the curtain airbag as part of the one-piece woven manufacturing process to form a construction seam.

12. The curtain airbag of claim 11, wherein the yarn that forms the construction seam is weaker than a yarn that is used to manufacture the rest of the curtain airbag.

13. The curtain airbag of claim 9, wherein the sealing portions release when the internal working pressure of the curtain airbag exceeds a design working pressure to allow inflation fluid to enter the respective relief chambers.

14. The curtain airbag of claim 9 having at least two relief chambers, the sealing portion of a first relief chamber of the at least two relief chambers being configured to release when the internal working pressure of the curtain airbag is at a first level, the sealing portion of a second relief chamber of the at least two relief chambers being configured to release when the internal working pressure of the curtain airbag is at a second level.

15. The curtain airbag of claim 14, wherein both the sealing portion of the first relief chamber and the sealing portion of the second relief chamber rupture when the internal working pressure is at the second level.

16. A curtain airbag for helping to protect an occupant of a vehicle comprising:
a first panel;
a second panel connected to the first panel to define an inflatable volume of the curtain airbag; and
a relief vent configured to open when an internal working pressure of the curtain airbag exceeds a design working pressure, the relief vent further being configured to close after opening when the internal working pressure of the airbag falls below the design working pressure.
